(19) United States
(12) Patent Application Publication
(10) Pub. No.: US 2007/0173593 A1
(43) Pub. Date: Jul. 26, 2007

(54) Dimer diol (meth)acrylates uses as a matting agent

(76) Inventors: Matthias Fies, Krefeld (DE); Holger Endres, Neuss (DE); Jan-Mirco Stachowiak, Essen (DE); Ronald Klagge, Erkrath (DE)

Correspondence Address: COGNIS CORPORATION;PATENT DEPARTMENT, 300 BROOKSIDE AVENUE, AMBLER, PA, 19002, US

(21) Appl. No.: 10/553,183

(22) PCT Filed: Apr. 8, 2004
(86) PCT No.: PCT/EP04/03784

§ 371 Date: Jul. 21, 2006

(30) Foreign Application Priority Data
Apr. 17, 2003 (DE) 103-17-645.4

(51) Int. Cl. C08L 31/00

(52) U.S. Cl. 524/556

(57) ABSTRACT

A new flatting agent for self-curing or radiation-curing coating systems is disclosed. The flatting agent is a liquid dimerdiol (meth)acrylate with a degree of esterification of at least 50%. The dimerdiol (meth)acrylate ester is introduced into the coating system in an amount of 1-25% by weight based on the coating system as a whole. The coating system can have additional solid flatting agents in the system.

### FIELD OF THE INVENTION

This invention relates to the use of dimerdiol (meth)acrylates with a degree of esterification of at least 50% as flatting agents for self-curing or radiation-curing coating systems, such as paints, coating compositions and the like.

### PRIOR ART

Certain applications require coating compositions which give gloss-reduced surfaces after application and curing. In the prior art, this goal is achieved by the use of substances which, in paint systems, reduce the surface gloss of the cured paint to a more or less considerable extent. Such substances are known to the expert as flatting agents. Accordingly, flatting agents are substances used as additives to reduce the surface gloss of cured paints or coatings. The term “flatting agent” is used in its universally accepted sense in the present specification.

The flatting agents known from the prior art are almost all solids.

DE-A-19917228 describes flatting agents containing thixotropic (meth)acrylic copolymers.

WO 01/04217 describes combinations of silicas with waxes as flatting agents, the compositions having to meet certain criteria in regard to particle size and pore volume.

U.S. Pat. No. 6,331,582 describes flatting agents consisting essentially of polyvinyl acetal containing acetal groups derived from aliphatic or aromatic aldehydes.

The particle size of solid flatting agents varies within wide limits. Whereas U.S. Pat. No. 5,316,843, for example, describes a combination of organic and inorganic solids with particle sizes below 10 μm, U.S. Pat. No. 4,927,710 describes acrylic fibers with a length of up to 3 mm as flatting agents.

### DESCRIPTION OF THE INVENTION

The disadvantage of solid flatting agents is mainly that the stirring in of solid constituents into a coating system basically leads to a considerable increase in the viscosity of that coating system. Paste-like, non-flowable products are often formed and cannot be further processed or applied.

Another disadvantage of solid flatting agents is that the layer thickness of the cured coating must be smaller than the particle size of the solid used as the flatting agent if the flatting effect is to be developed at all. If relatively thick layers are applied before the curing process, the flatting effect is only developed when either the layer thickness of the coating composition falls below the particle size through shrinkage in the course of the curing process or the curing process takes place in a form which enables the solid flatting agent to float to the surface of the layer, so that the flatting effect is developed at the surface. In either case, serious limits are imposed on the formulator.

The problem addressed by the present invention was to provide flatting agents which would be liquid rather than solid at 20° C. and which would not have any of the disadvantages mentioned above. These flatting agents would be effective and would be particularly suitable for radiation-curing coatings, would develop their effect in low concentrations and would not adversely affect the viscosity of coating or paint formulations (coating systems in general).

It has now surprisingly been found that the esters of dimer diol with acrylic and/or methacrylic acid—hereinafter referred to as dimerdiol (meth)acrylates—excellently satisfy the requirements stated above in every respect. Although liquid in consistency at 20° C., they have a pronounced flatting effect and may be used with advantage as flatting additives, i.e. as flatting agents, both in typical self-curing coating systems and in radiation-curing coating systems, including—as known to the expert—paints, coating compositions and the like. In particular, dimerdiol (meth)acrylates do not increase the viscosity of the coating systems to which they are added. In addition, even relatively thick paint coatings can readily be flatted with dimerdiol (meth)acrylates.

The present invention relates to the use of dimerdiol (meth)acrylates with a degree of esterification of at least 50% as flatting agents for self-curing or radiation-curing coating systems, such as paints, coating compositions and the like.

Dimerdiol (meth)acrylates in the context of the invention are esters of dimerdiol and acrylic and/or methacrylic acid. The dimer diol on which the dimerdiol (meth)acrylates are based may be present as such or in technical quality. As already mentioned, the dimerdiol (meth)acrylates to be used in accordance with the invention have a degree of esterification of at least 50%. Their degree of esterification is preferably at least 80% and, more particularly, at least 92%. In a most particularly preferred embodiment, the degree of esterification is 100%, i.e. the esters are full esters, i.e. dimerdiol di(meth)acrylates. In the interests of clarity, it is pointed out that a degree of esterification of x% means that, where 1 mol dimer diol is used to produce a dimerdiol (meth)acrylate, x% of all the OH groups present therein are esterified.

In terms of handling behavior and incorporation in coating systems, the supply form of a flatting agent which is liquid at 20° C. represents a major advantage over conventional flatting agents which are solid at 20° C.

The viscosity of the dimerdiol (meth)acrylates is about 300 mPas at 20° C. so that, in contrast to the known flatting agents solid at 20° C., the viscosity of coating systems, to which they are added as flatting agents, is reduced where these coating systems have a higher viscosity than 300 mPas at 20° C. This generally results in easier processing of the coating systems which is a major advantage both for the formulator and for the user. The viscosities mentioned are measured with a Brookfield Model LV/DV-II viscosimeter (spindle 63, 20 r.p.m.) at 20° C.

Dimerdiol (meth)acrylates can be obtained, for example, by esterification of dimer diols with acrylic acid or methacrylic acid or mixtures of acrylic and methacrylic acid. The dimer diols may be used either as such or in technical quality (see below).

Dimerdiols are well-known commercially available compounds which are obtained, for example, by reduction of dimer fatty acid esters. The dimer fatty acids on which these dimer fatty acid esters are based are carboxylic acids which may be obtained by oligomerization of unsaturated carboxylic acids, generally fatty acids, such as oleic acid, linoleic acid, erucic acid and the like. The oligomerization is normally carried out at elevated temperature in the presence of a catalyst, for example of clay. The substances obtained—dimer fatty acids of technical quality—are mixtures in which the dimerization products predominate. However, small amounts of higher oligomers, more particularly so-called trimer fatty acids, are also present. Dimer fatty acids are commercially available products and are marketed in various compositions and qualities. Abundant literature is available on the subject of dimer fatty acids, cf. for example the following articles: Fette & Öle 26 (1994), pages 47-51; Speciality Chemicals 1984 (May Number), pages 17, 18, 22-24. Dimerdiols are well-known among experts, cf. for example a more recent article in which inter alia the production, structure and chemistry of the dimerdiols are discussed: Fat Sci. Technol. 95 (1993), No. 3, pages 91-94. According to the invention, dimerdiols preferred as raw materials for the production of dimerdiol (meth)acrylates are those which have a dimer content of at least 70% and more particularly 90% and in which the number of carbon atoms per dimerdiol molecule is mainly in the range from 36 to 44.

The dimerdiol (meth)acrylates to be used in accordance with the invention may readily be incorporated in standard coating systems. They may be introduced into standard coating systems and homogeneously distributed therein, for example by stirring.

The quantity of dimerdiol (meth)acrylates in coating systems may be selected according to technical requirements by the formulator. They are in the range from 1 to 25% by weight, preferably in the range from 2 to 15% by weight and more particularly in the range from 3 to 10% by weight, based on the coating system as a whole.

According to studies conducted by applicants, the flatting effect increases with increasing content of dimerdiol (meth)acrylate in the coating systems. However, where the dimerdiol (meth)acrylates are used in radiation-curing coating systems, it is important to ensure that the quantity in which they are used is not too high, so that the crosslinking rate and hence the curing of the coating composition are not overly reduced by a “diluting effect” of the flatting agent comparatively poorer in C═C double bonds than the resins to be crosslinked present in the radiation-curing coating compositions.

In contrast to the prior art, there is no upper limit to the layer thickness.

The dimerdiol (meth)acrylates may also be used in combination with other flatting agents. The flatting effect can be enhanced in this way.

The flatting effect of the dimerdiol (meth)acrylates was observed on various substrates including, for example, glass, metal, wood, paper, ceramic, plastic. It is particularly pronounced on glass.

Suitable basic formulations for radiation-curing, flatting coating systems are, for example, polyester acrylates, epoxy acrylates or urethane acrylates and any combination thereof.

The present invention also relates to coating systems containing dimerdiol (meth)acrylates with a degree of esterification of at least 50%. The dimerdiol (meth)acrylates act as a flatting agent in these coating systems.

The present invention also relates to a process for the production of coatings, in which additives of the dimerdiol (meth)acrylate type with a degree of esterification of at least 50% are added to standard self-curing or radiation-curing coating systems, such as paints, coating compositions and the like, and the coating systems are then cured. The dimerdiol (meth)acrylates are added to the coating systems in a quantity of 1 to 25% by weight, based on the coating system as a whole. Other typical flatting agents may also be added to the coating systems.

### EXAMPLES

Substances Used

Photomer 3016=bisphenol-A-diglycidyl ether diacrylate (Cognis)
Photomer 4226=dipropylene glycol diacrylate (Cognis)
Photomer 5025F=difunctional polyether acrylate (Cognis)
Darocur 1173=photoinitiator (Ciba Speciality Chemicals)
Photomer BP=photoinitiator (Cognis)
Gasil UV 70C=commercial flatting agent (INEOS Silicas)
Texaphor P61=commercial dispersion aid (Cognis)

All the percentages in the following Examples are percentages by weight.

### Example 1

Dimer diol diacrylate was added with stirring at 20° C. to, and uniformly distributed in, a clear lacquer formulation of
58.5% Photomer 3016
38.5% Photomer 4226,
2% Darocur 1173 and
1% Photomer BP
   in quantities of 0%, 5%, 10% and 20%, based on the formulation as a whole. The lacquer thus flatted was applied to a glass plate in a layer thickness of 100 μm and cured with UV light.

Using a laboratory reflectometer (Dr. Lange), the gloss of the cured film was then measured at an angle of 60°. The results are set out in Table 1 below.

TABLE 1

| Addition of dimer diol diacrylate | |
|---|---|
| [%] | Gloss [gloss units] |
| 0 | 124.3 |
| 5 | 108.1 |
| 10 | 95.6 |
| 20 | 78.2 |

### Example 2

To produce a finishing paint for wood, 10.40% Gasil UV 70C and 1.25% Texaphor P61 were stirred into 50.80% Photomer 5025 F at 20° C. 21.25% Photomer 5025 F, 2.50% Darocur 1173 and 1.25% Photomer BP and, finally, 12.50% dimer diol diacrylate, based on the formulation as a whole, were then added.

The paint thus produced was applied to a glass plate in a layer thickness of 100 μm and cured with UV light.

The cured film had a gloss of 111.1 gloss units. This is a clear flatting effect in relation to the following Comparison Example.

### Comparison Example

To produce a finishing paint for wood, 10.40% Gasil UV 70C and 1.25% Texaphor P61 were stirred into 50.80% Photomer 5025 F at 20° C. 33.80% Photomer 5025 F and 2.50% Darocur 1173 and 1.25% Photomer BP (photoinitiators), based on the formulation as a whole, were then added.

The paint thus produced was applied to a glass plate in a layer thickness of 100 μm and cured with UV light. The cured film had a gloss of 135.6 gloss units.

1-5. (canceled)

6. A self-curing and/or radiation curing flatted coating system containing a flatting agent comprising a liquid-dimerdiol (meth)acrylate with a degree of esterification of at least 50%.

7. The coating system of claim 6, wherein, the dimerdiol (meth)acrylate has a degree of esterification of at least 80%.

8. The coating system of claim 6 containing from 1% to 25% by weight of the dimerdiol (meth)acrylate.

9. The coating system of claim 8 further comprising a solid flatting agent.

10. The coating system of claim 8, wherein, the dimerdiol (meth)acrylate has a degree of esterification of at least 80%.

11. A process for producing a flatted coating which comprises:
(a) introducing into a self-curing or radiation-curing coating system a liquid dimerdiol (meth)acrylate flatting agent with a degree of esterification of at least 50% to form a flatted coating system;
(b) applying a coating of the flatted coating system to a substrate; and
(c) curing the coating.

12. The process of claim 11, wherein, from 1% to 25% by weight of the dimerdiol (meth)acrylate is added to the coating system based on the weight of the coating system.

13. The process of claim 11, wherein, the dimerdiol (meth)acrylate has a degree of esterification of at least 80%.

14. The process of claim 11, wherein, the flatting agent further comprises a solid flatting agent.

15. The process of claim 12, wherein, the dimerdiol (meth)acrylate has a degree of esterification of at least 80%.

16. The process of claim 12, wherein the flatting agent further comprises a solid flatting agent.
